(19) United States
(12) Patent Application Publication
(10) Pub. No.: US 2009/0150925 A1
(43) Pub. Date: Jun. 11, 2009

(54) System and Method of Providing An Alert

(75) Inventor: Donnie Henderson, Manalapan, NJ (US)

Correspondence Address: AT & T LEGAL DEPARTMENT - Toler;ATTN: PATENT DOCKETING, ROOM 2A-207, ONE AT & T WAY, BEDMINISTER, NJ, 07921, US

(73) Assignee: AT&T Labs, Inc., Austin, TX (US)

(21) Appl. No.: 11/951,707

(22) Filed: Dec. 6, 2007

(51) Int. Cl. H04N 7/025; H04N 7/10

(52) U.S. Cl. 725/34

(57) ABSTRACT

In a particular embodiment, a method of providing an alert related to visual ticker data for display at a display device is disclosed. The method includes receiving media content at a destination device. The media content includes video data, audio data, and visual ticker data. The method also includes generating an alert related to the visual ticker data, providing the media content to a display device and selectively providing data related to the alert to a selected device based on a user preference.

### FIELD OF THE DISCLOSURE

The present disclosure is generally related to a system and method of providing an alert.

### BACKGROUND

Conventionally, television broadcasts may be sent from a head-end media content system to a set-top box device at a subscriber's residence. The set-top box device may decode the television broadcast to provide decoded media content to a display device, such as a television set. In general, media content that is associated with the television broadcast may include overlay information, such as banners and news tickers, which may include graphics and text content. However, when a viewer's attention is focused on the broadcast content or is focused elsewhere, the news ticker information may be missed. In addition, such news tickers often repeat information and typically provide no easily discernable cue that something new is being presented within the ticker information stream.

### BRIEF DESCRIPTION OF THE DRAWINGS

FIG. 1 is a block diagram of a particular illustrative embodiment of a system to provide an alert;

FIG. 2 is a block diagram of a second particular illustrative embodiment of a system to provide an alert;

FIG. 3 is a diagram of a third particular illustrative embodiment of a system to provide an alert;

FIG. 4 is a block diagram of a particular illustrative embodiment of an Internet Protocol Television (IPTV) system adapted to provide an alert;

FIG. 5 is a block diagram of a particular illustrative embodiment of a system to provide a graphical user interface to configure an alert;

FIG. 6 is a diagram of a particular illustrative embodiment of a graphical user interface to configure an alert;

FIG. 7 is a diagram of a second particular illustrative embodiment of a graphical user interface to configure an alert;

FIG. 8 is a flow diagram of a particular illustrative embodiment of a method of providing an alert;

FIG. 9 is a flow diagram of a second particular illustrative embodiment of a method of providing an alert;

FIG. 10 is a flow diagram of a third particular illustrative embodiment of a method of providing an alert; and

FIG. 11 is a block diagram of a particular representative embodiment of a computing system adapted to execute instructions.

### DETAILED DESCRIPTION OF THE DRAWINGS

In a particular embodiment, an alert generation system to provide an alert is disclosed. The system includes a content analysis engine that is adapted to receive media content including audio data, video data, and text data. The content analysis engine identifies selected content from the media content based on a user profile. The system also includes a text-to-speech converter that is adapted to convert text data associated with the selected content into converted audio data. The system further includes an alert generator that is adapted to generate an alert based on the converted audio data and includes an alert interface that is adapted to selectively transmit data related to the generated alert to one or more destination devices according to the user profile.

In a particular embodiment, a method of providing an alert related to visual ticker data for display at a display device is disclosed. The method includes receiving media content at a destination device. The media content includes video data, audio data, and visual ticker data. The method also includes generating an alert related to the visual ticker data, providing the media content to a display device and selectively providing data related to the alert to a selected device based on a user preference.

In still another particular embodiment, a method of providing an alert is disclosed that includes analyzing media content including a visual ticker to be sent to a destination device to identify ticker content based on a user profile. The media content includes video data, audio data, and text data. The method also includes sending the media content to the destination device and sending an alert related to the visual ticker to at least one device associated with a user based on the user profile.

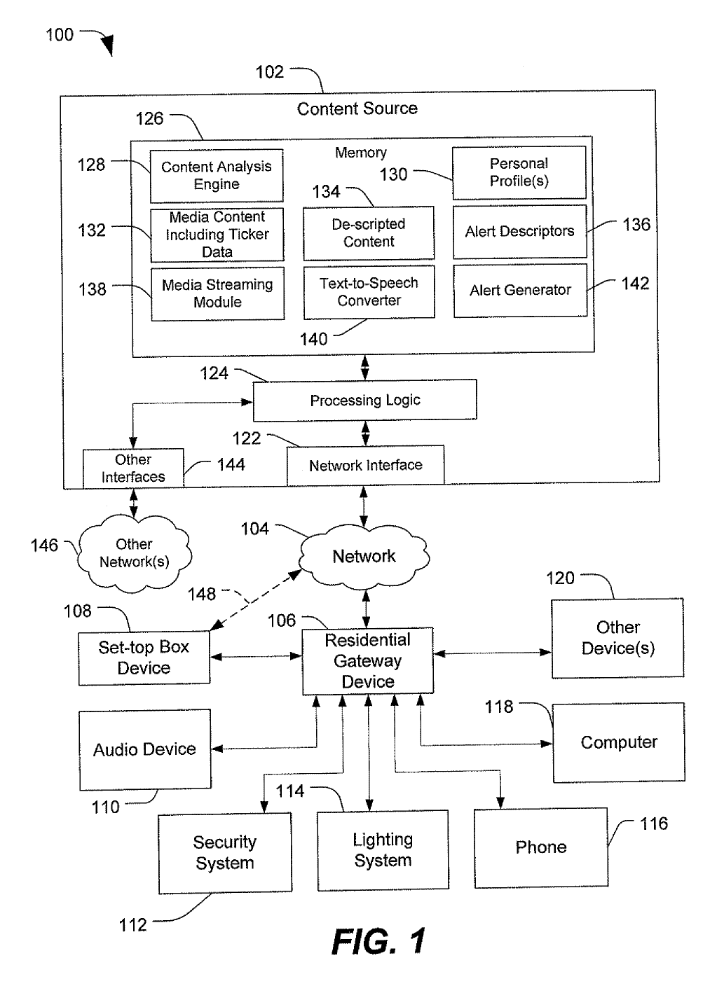

FIG. 1 is a block diagram of a particular illustrative embodiment of a system 100 to provide an alert. The system 100 includes a content source 102 that communicates with a residential gateway 106 via a network 104. The residential gateway 106 is adapted to communicate with one or more devices, such as a set-top box device 108, an audio device 110 (such as a speaker), a security system 112, a lighting system 114, a phone 116, a computer 118, other devices 120, or any combination thereof. In a particular embodiment, the residential gateway 106 is a computing device that is adapted to communicate with and/or control one or more systems. In another particular embodiment, the residential gateway 106 is a set-top box device, such as the set-top box device 108, which is coupled to the network 104 (e.g., via a connection 148). In a particular embodiment, the set-top box device 108 includes a wireless network capability that can be used to provide wireless local area network connectivity to communicate with the one or more of the devices 110, 112, 114, 116, 118, and 120.

In a particular embodiment, the content source 102 is a system associated with a cable television provider, a phone company, a video-on-demand company, an Internet company that provides streaming media content, another content source, or any combination thereof. The content source 102 includes a network interface 122 to communicate with the network 104, processing logic 124 that is coupled to the network interface 122, and a memory 126 that is accessible to the processing logic 124. In a particular embodiment, the processing logic 124, the network interface 122, and the memory 126 are distributed among a plurality of servers. In another particular embodiment, the processing logic 124 is a processor, and the processing logic 124 and the memory 126 are included within a single server.

The memory 126 is adapted to store a plurality of modules that may be executed by the processing logic 124 to provide an alert. The memory 126 includes a content analysis engine 128 that is executable by the processing logic 124 to analyze media content to identify portions of the media content that include data of interest to a particular user. In a particular embodiment, the media content includes video data, audio data, and visual ticker data. The visual ticker data may include text data and graphics. For example, in a television broadcast, the visual ticker data may be presented as an overlay along the bottom or across the top of the video display. For example, the visual ticker data may be presented as a scrolling news ticker that scrolls or moves across the screen from left to right. The visual ticker data may also be presented as a popup, a banner, or other visual indicator within the media content. The visual ticker data may include breaking news, weather information, financial data, sports information, advertising, other information, or any combination thereof.

The memory 126 is adapted to store media content including ticker data at a storage area 132. In a particular embodiment, the media content including ticker data is stored at the storage area 132 before or after the content analysis engine 128 is used to analyze the media content. The memory 126 is also adapted to store de-scripted (i.e., processed) media content at a storage area 134. The de-scripted content may include content descriptors, key words, and other information that can be derived from the media content based on execution of the content analysis engine 128. The memory 126 also includes a personal profile(s) storage area 130, which is adapted to store user profile information, which may be associated with a subscriber account, such as a television subscriber account. The personal profile(s) storage area 130 may include data related to one or more user profiles. In a particular example, the personal profile(s) storage area 130 includes user usage information, account history information, user preferences, keywords, alert communication preferences, other information, or any combination thereof. In a particular example, the alert communication preferences include one or more communication devices associated with a user, desired alert formats for each of the one or more communication devices, and schedule information related to times and days for transmission of alerts. In a particular example, a subscriber may update information stored at the personal profile(s) storage area 130 to register one or more communication devices, such as a mobile telephone, a pager, and a computer. The subscriber may also update information stored at the personal profile(s) storage area to provide an email address or an instant messaging account. In a particular example, the subscriber may update preferences stored at the personal profile(s) storage area 130 to direct alerts to an email address or instant messaging account during business hours and to a mobile telephone as a ring tone during non-business hours. In another particular example, the subscriber may direct financial alerts (such as stock price information) to a mobile phone, such as the phone 116, as a ring tone during business hours so that the user can receive timely financial information during business hours.

The memory 126 also includes an alert descriptor(s) storage area 136 that is adapted to store data related to particular descriptors within the media content and related to the associated ticker data. The content analysis engine 128 may be adapted to use such descriptors to identify media content that may be of interest to a viewer. The memory 126 includes an alert generator 142 that can be executed by the processing logic 124 to generate an alert based on the de-scripted media content at the storage area 134 and/or based on data determined by the content analysis engine 128. In a particular example, the alert generator 142 is adapted to generate an instruction to alter the media content by changing a tone, a visual effect, a color, other visual or audio features of the media content, or any combination thereof. The altered media content may be sent to a destination device, such as the residential gateway 106, via the media streaming module 138, which is executable by the processing logic 124 to stream the media content.

The memory 126 further includes a text-to-speech converter 140 that is executable by the processing logic 124 to convert selected text data into an audio version of the text data. The alert generator 142 may be used to generate an audio alert based on the audio version of the text data. For example, the alert generator 142 may combine a short tone and the audio version of the text data to form a ring tone for transmission to a mobile telephone device. The alert generator 142 may provide the audio alert to the media streaming module for inclusion with the media content for streaming to a destination device. In a particular illustrative embodiment, the alert generator 142 can provide the audio alert to one or more selected devices that are associated with the user via the network interface 122 or via other interfaces 144, which may communication with one or more other networks 146. In a particular example, the other interfaces 144 include an interface to a cellular or digital network for communication with a wireless communication device, such as a wireless telephone. In this example, the alert generator 142 may provide data related to the alert to the other interfaces 144 for wireless transmission via the other networks 146 to mobile communication device. In a particular illustrative embodiment, the data related to the alert can be a ring tone that includes an audio version of the text data derived from the media content.

In a particular illustrative embodiment, the content source 102 may utilize the content analysis engine 128 to process media content, including audio data, video data, and visual ticker data (such as a scrolling news ticker). The content analysis engine 128 may detect visual ticker data that is of interest to a user based on information contained in the personal profile(s) storage 130 and/or based on one or more alert descriptors at the alert descriptors storage area 136. The content analysis engine 128 may provide the detected ticker data content to the text-to-speech converter 140, which can convert text data to an audio version of the text data. The text-to-speech converter 140 provides the audio version of the text data to the alert generator 142, which generates one or more alerts based on the audio version of the text data and according to user preference data stored at the personal profile(s) storage 130.

In a particular example, the alert generator 142 generates a ring tone alert including the audio version of the text data for transmission to a mobile telephone. In another particular example, the alert generator 142 generates an email or instant message alert including the text data. In still another particular example, the alert generator 142 alters a characteristic of the media content, such as color, brightness, audio tone or volume, to draw attention to the ticker data information. In yet another particular example, the alert generator 142 inserts the audio version of the text data into the media content for transmission to a destination device. In another example, the alert generator 142 generates a control signal to control the lighting system 114 or the security system 112 (e.g., an audio alarm for audio reproduction at the security system 112) to produce a visual or audio effect, respectively. In yet another particular embodiment, the alert generator 142 may send data related to the alert to an audio device 110, to a computer 118, or to other devices 120, which may output an audio signal based on the data. In general, the alert generator 142 is adapted to produce an alert in one or more formats (i.e., email, audio alert, ring tone alert, control signal alert, other alert format, or any combination thereof to draw the attention of the user to the visual ticker data, which might otherwise be missed if the viewer were not paying attention.

In a particular example, the alert generator 142 is adapted to determine time and day information and to generate an alert in a format that is selected based on the time and day information. For example, when the alert is generated during business hours on a weekday, the alert may be generated for transmission by email and by ring tone. In another example, when the alert is generated on a weekend, the alert may be generated in a format for transmission via email or instant message.

In a particular example, the content analysis engine 128 and the alert generator 142 are adapted to produce alerts related to a current channel being viewed. In another particular example, the content analysis engine 128 is independent of the channel being viewed. In this example, the content analysis engine 128 is configured to monitor one or more channels and to generate alerts based on visual ticker data communicated within the media content of the one or more channels, independent of whether the viewer's television is on.

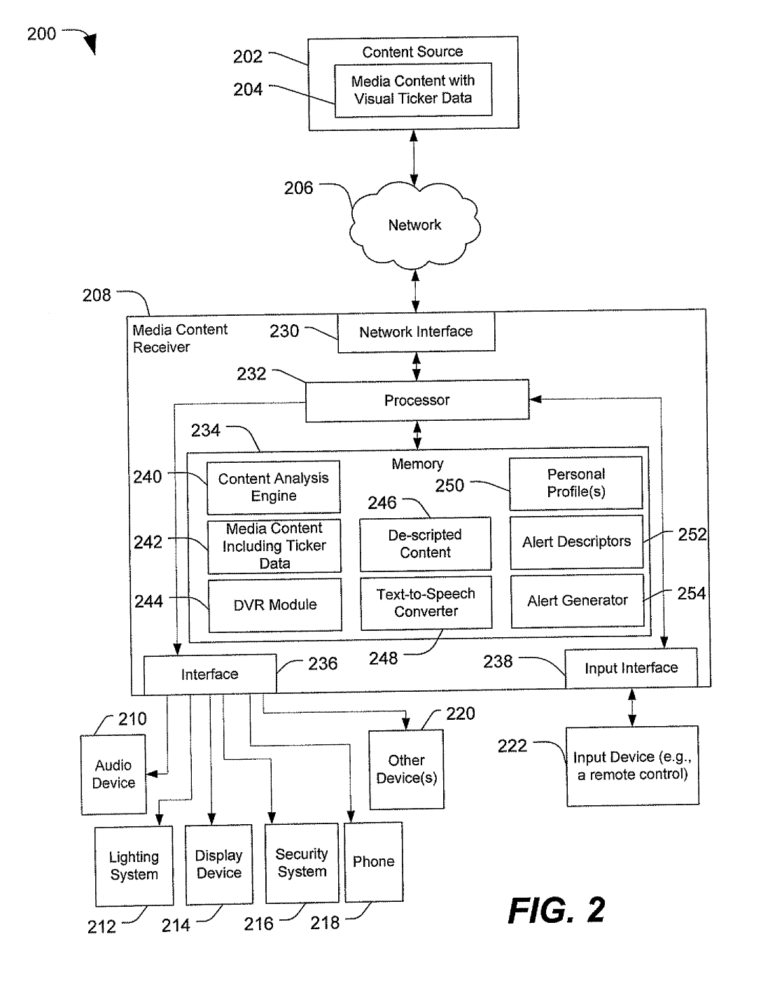

FIG. 2 is a block diagram of a second particular illustrative embodiment of a system 200 to provide an alert. The system 200 includes a content source 202 that communicates media content with visual ticker data 204 to a media content receiver 208 via a network 206. The media content receiver 208 is adapted to communicate with an input device 222, such as a remote control. The media content receiver 208 is also adapted to communicate with one or more other devices, such as an audio device 210, a lighting system 212, a display device 214 (such as a liquid crystal display (LCD) monitor, a television, another display device, or any combination thereof), a security system 216, a phone 218 (e.g., a wireless phone), other devices 220, or any combination thereof. In a particular embodiment, the other devices 220 can include a personal digital assistant (PDA), a personal computer, a pager device, a home stereo system, a music player device, a gaming system, other electronic devices, or any combination thereof.

In a particular example, the media content receiver 204 is a set-top box device that is coupled to a television set, such as the display device 214. In a particular embodiment, the media content receiver 204 and the display device 214 are located at a subscriber's residence. In this example, the content source 202 may be provided by a cable company, a broadcast television company, a telephone company, an Internet Service Provider (ISP), a pay-per-view content provider, another content provider, or any combination thereof.

The media content receiver 208 includes a network interface 230 to communicate with the network 206, a processor 232 that is coupled to the network interface 230 and that is coupled to an interface 236 and to an input interface 238. The interface 236 is adapted to communicate with one or more devices, such as the audio device 210, a lighting system 212, a display device 214, a security system 216, a telephone 218, other devices 220, or any combination thereof. In a particular embodiment, the interface 236 includes a wireless transceiver that is adapted to communicate with one or more of the other devices via a short-range wireless protocol, such as an 802.11x-type of wireless protocol. The media content receiver 208 also includes a memory 234 that is accessible to the processor 232.

In a particular embodiment, the interface 236 is adapted to communicate data to a first destination device, such as a lighting system via a first communication protocol, such as a simple control signal protocol. The interface 236 is adapted to communicate data to a second destination device, such a telephone 218, an audio device, or other devices 220 (such as a computer) via a second communication protocol, such as an Internet Protocol (IP) communications protocol. In another particular embodiment, the interface 236 may include a wireless transceiver and one or more wired interfaces to communicate with a first communication network and a second communication network. For example, the interface 236 communicates with a home-control network via a control signal protocol (such as a Jini technology protocol introduced by Sun Microsystems®) and communicates with a computer via an IP communication protocol via an 802.11x wireless network.

The memory 234 is adapted to store one or more modules that can be executed by the processor 232 to provide an alert. The memory 234 includes a content analysis engine 240 that is executable by the processor 232 to process media content received via the network 206. In a particular embodiment, the content analysis engine 240 may be used to process media content including visual ticker data that is stored locally at a storage location 242 using a digital video recorder (DVR) module 244. The content analysis engine 240 is adapted to process the media content to identify visual ticker data (and other content) that may be of interest to a user of the media content receiver 208. For example, the media content receiver 208 may create (or receive) subscriber profile information, which may be stored at a subscriber profile(s) storage area 250 within the memory 234. The content analysis engine 240 may utilize such profile information stored at the profile(s) storage area 250 and alert descriptors data stored at the alert descriptors storage location 252 to identify particular descriptors or terms within the media content (and/or within the visual ticker data). The content analysis engine 240 may extract the identified descriptors, terms, associated media content, or any combination thereof, and the extracted information may be stored at a de-scripted content storage location 246 within the memory 234. The memory 234 also includes an alert generator 254 that is executable by the processor 232 to access the alert descriptor storage location 252, the personal profile(s) storage area 250, and the de-scripted content 246 to generate an alert related to the de-scripted content and according to the profile information and the alert descriptors.

In a particular example, the alert generator 254 triggers execution of a text-to-speech converter 248, which is adapted to convert the de-scripted content stored at the storage location 246 to produce an audio version of the de-scripted content. The alert generator 254 may generate an audio alert based on the audio version of the de-scripted content. The alert generator 254 is adapted to select a device associated with the user for receipt of an alert based on the user profile information stored at the personal profile(s) storage location 250. The alert generator 254 may provide an alert to the interface 236 for transmission to the selected device.

In a particular illustrative embodiment, the alert generator 254 is adapted to identify a device that is associated with the user. The device may be identified based on user preferences that are configured by the user and stored at the personal profile(s) storage location. For example, the device may be registered by a user by entering a phone number, an email address, an Internet Protocol (IP) address, and so on. The user profile information may also include subject matter-specific settings that direct particular types of information to different devices. The user profile information may also include schedule information that directs an alert to a particular device during a first time period and to another device during a second time period.

In a particular example, the media content receiver 208 receives media content including visual ticker information from the content source 202 via the network 206. The media content is received at the network interface 230 and provided to the processor 232. The processor 232 executes the content analysis engine 240 to process the media content to identify descriptors or data of interest to a particular user. The processor 232 uses the content analysis engine 240 to extract information, executes the text-to-speech converter 248 to generate an audio version of the extracted information (if necessary), and executes the alert generator 254 to generate an alert based on the extracted information. In a first example, the alert generator 254 generates an instruction that is executable by the processor 232 to alter a portion of the media content, such as a color or brightness associated with particular content, an audio characteristic, or any combination thereof. The processor 232 provides the altered media content including the visual ticker data to the display device 214 via the interface 236, and the display device 214 displays the media content including the altered feature.

In another example, the alert generator 254 generates an audio version of text data including the visual ticker data, inserts the audio version into the media content as an alert such that the audio version has a different audio characteristic from other audio data of the media content, and provides the media content and the audio alert to at least one device. In a particular embodiment, the alert interface 236 sends the media content with the visual ticker data to the display device 214 and sends the alert to another device, such as to the phone 218.

In a particular illustrative embodiment, the interface 236 may include a cellular interface or a telephone interface adapted to initiate a wireless telephone call to the phone 218 including a ring tone that includes the extracted information. In another particular embodiment, the interface 236 may send a text message to the phone or to another device. In another particular embodiment, the interface 236 may send a control signal to the lighting system 212 to flicker or otherwise alter the lights.

In a particular example, the media content receiver 208 uses the alert generator 254 to control audio effects, visual effects, environmental effects, or any combination thereof in order to attract a viewer's attention to visual ticker information that might otherwise be overlooked. In a particular example, the alert generator 254 may generate a personalized alert, such as “Hey Don! Check this out!,” in order to grab the viewer's attention. In another example, the alert generator 254 may send a ring tone that includes an audio version of the visual ticker data to a mobile phone, such as the phone 218, so that the visual ticker information is being played as an alert by the phone 218 while the display device 214 is displaying a text version of the same information.

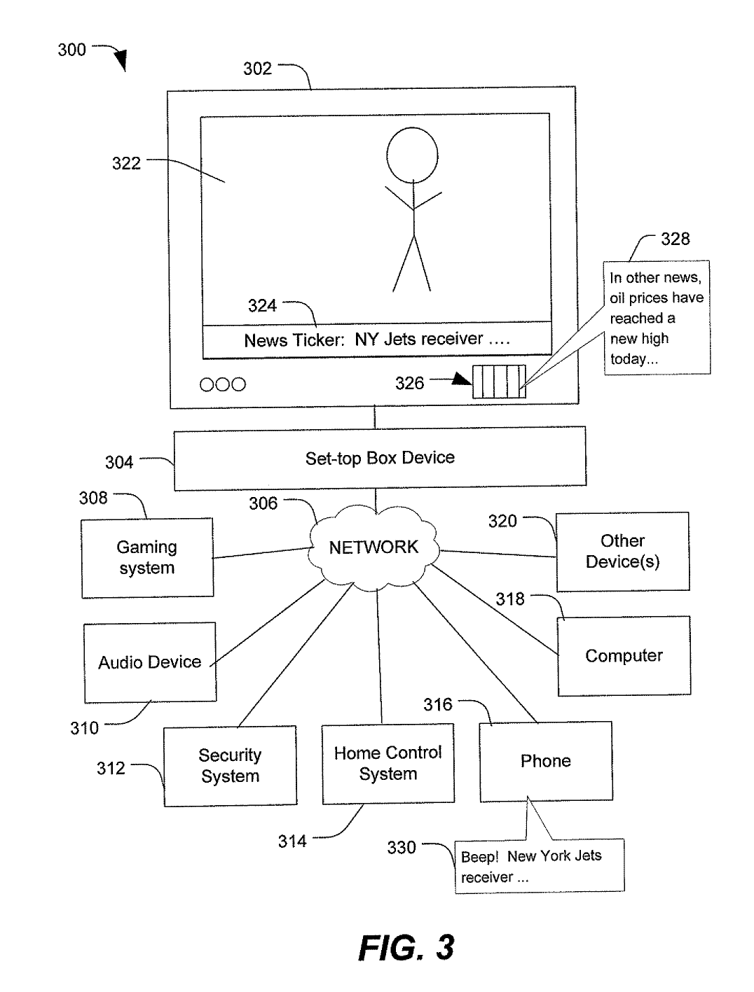

FIG. 3 is a diagram of a third particular illustrative embodiment of a system 300 to provide an alert. The system 300 includes a display device 302 that communicates with a set-top box device 304. The set-top box device 304 is adapted to communicate with one or more other devices via a local area network 306. For example, the set-top box device 304 may communicate with a gaming system 308. Additionally, the set-top box device 304 is adapted to communicate with an audio device 310 (such as a speaker or an audio receiver system), a security system 312, a home control system 314, a phone 316, a computer 318, other devices 320, or any combination thereof.

The display device 302 receives the media content including the visual ticker data from the set-top box device 304 and provides the video data 322 associated with the media content and the visual ticker data 324 to the display device 302 for display. In a particular example, the set-top box device 304 receives or generates an audio alert related to the visual ticker data 324. In the embodiment shown, the display device includes a speaker 326 that produces an audio output 328 based on audio data included in the media content. In a particular embodiment, the set-top box device 304 is adapted to provide the audio alert as a ring tone to the phone 316, which may produce the audio output 330 of the visual ticker data 324 as a ring tone. In an alternative embodiment, the phone 316 may receive the call and the associated ring tone from a cellular network. The call may originate from the set-top box device 304, from a content source (such as the content sources 102 and 202 illustrated in FIGS. 1 and 2), from another source, or any combination thereof). In this particular example, the speaker 326 of the display device 302 provides an audio output 328, such as “In other news, oil prices have reached a new high today . . . ” Concurrently, the phone 316 plays a ring tone 330 that includes a “Beep” sound followed by an audio version of the visual ticker data 324, e.g., “New York Jets receiver . . . ”

In another particular embodiment, the alert is produced as an audio alert and may be inserted into the audio data of the media content such that the speaker 326 of the display device 302 may produce both the audio content associated with the media content and the audio alert. In this example, the audio alert may be produced at a different volume level, with a different tonal quality, during moments of silence, or any combination thereof.

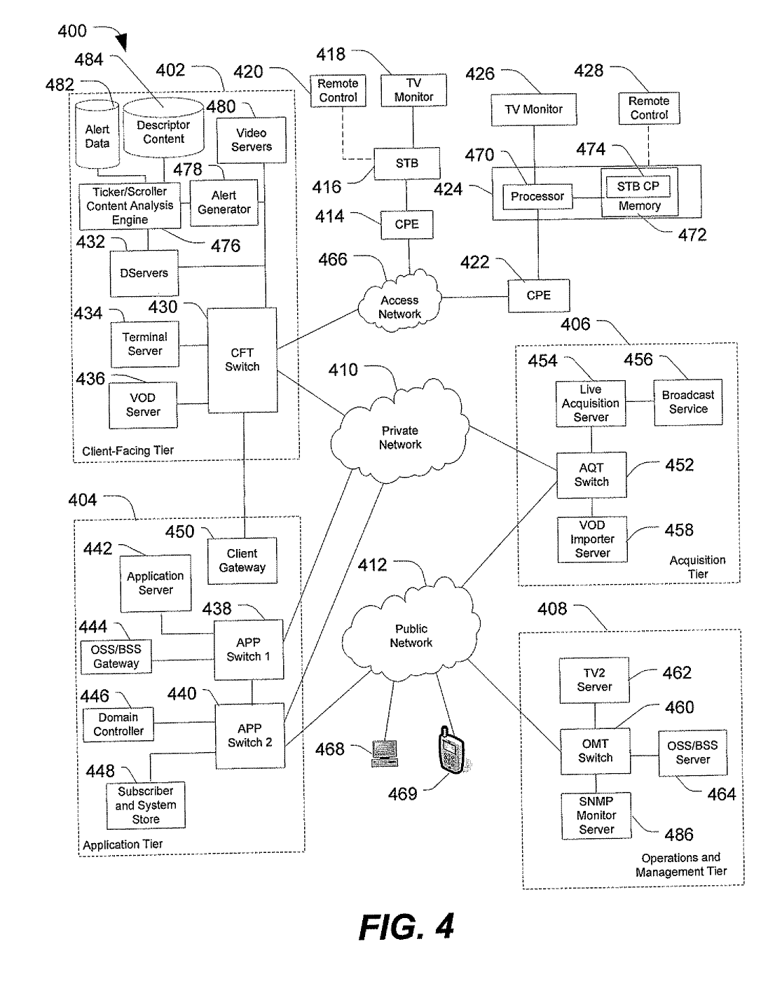

FIG. 4 is a block diagram of a particular illustrative embodiment of an Internet Protocol Television (IPTV) system adapted to provide an alert. Referring to FIG. 4, an illustrative embodiment of an Internet Protocol Television (IPTV) system that may be used to provide a set-top box application is illustrated and is generally designated 400. As shown, the system 400 can include a client facing tier 402, an application tier 404, an acquisition tier 406, and an operations and management tier 408. Each tier 402, 404, 406, 408 is coupled to a private network 410; to a public network 412, such as the Internet; or to both the private network 410 and the public network 412. For example, the client-facing tier 402 can be coupled to the private network 410. Further, the application tier 404 can be coupled to the private network 410 and to the public network 412. The acquisition tier 406 can also be coupled to the private network 410 and to the public network 412. Additionally, the operations and management tier 408 can be coupled to the public network 412.

As illustrated in FIG. 4, the various tiers 402, 404, 406, 408 communicate with each other via the private network 410 and the public network 412. For instance, the client-facing tier 402 can communicate with the application tier 404 and the acquisition tier 406 via the private network 410. The application tier 404 can communicate with the acquisition tier 406 via the private network 410. Further, the application tier 404 can communicate with the acquisition tier 406 and the operations and management tier 408 via the public network 412. Moreover, the acquisition tier 406 can communicate with the operations and management tier 408 via the public network 412. In a particular embodiment, elements of the application tier 404, including, but not limited to, a client gateway 450, can communicate directly with the client-facing tier 402.

The client-facing tier 402 can communicate with user equipment via an access network 466, such as an Internet Protocol Television (IPTV) access network. In an illustrative embodiment, customer premises equipment (CPE) 414, 422 can be coupled to a local switch, router, or other device of the access network 466. The client-facing tier 402 can communicate with a first representative set-top box device 416 via the first CPE 414 and with a second representative set-top box device 424 via the second CPE 422. In a particular embodiment, the first representative set-top box device 416 and the first CPE 414 is located at a first customer premise, and the second representative set-top box device 424 and the second CPE 422 is located at a second customer premise. In another particular embodiment, the first representative set-top box device 416 and the second representative set-top box device 424 are located at a single customer premise and are coupled to one of the CPE 414, 422. The CPE 414, 422 can include routers, local area network devices, modems, such as digital subscriber line (DSL) modems, any other suitable devices for facilitating communication between a set-top box device and the access network 466, or any combination thereof.

In an exemplary embodiment, the client-facing tier 402 can be coupled to the CPE 414, 422 via fiber optic cables. In another exemplary embodiment, the CPE 414, 422 can include digital subscriber line (DSL) modems that are coupled to one or more network nodes via twisted pairs, and the client-facing tier 402 can be coupled to the network nodes via fiber-optic cables. Each set-top box device 416, 424 can process data received via the access network 466, via an IPTV software platform, such as Microsoft® TV IPTV Edition.

The first set-top box device 416 can be coupled to a first external display device, such as a first television monitor 418, and the second set-top box device 424 can be coupled to a second external display device, such as a second television monitor 426. Moreover, the first set-top box device 416 can communicate with a first remote control 420, and the second set-top box device 424 can communicate with a second remote control 428. The set-top box devices 416, 424 can include IPTV set-top box devices; video gaming devices or consoles that are adapted to receive IPTV content; personal computers or other computing devices that are adapted to emulate set-top box device functionalities; any other device adapted to receive IPTV content and transmit data to an IPTV system via an access network; or any combination thereof.

In an exemplary, non-limiting embodiment, each set-top box device 416, 424 can receive data, video, or any combination thereof, from the client-facing tier 402 via the access network 466 and render or display the data, video, or any combination thereof, at the display device 418, 426 to which it is coupled. In an illustrative embodiment, the set-top box devices 416, 424 can include tuners that receive and decode television programming signals or packet streams for transmission to the display devices 418, 426. Further, the set-top box devices 416, 424 can include a STB processor 470 and a STB memory device 472 that is accessible to the STB processor 470. In one embodiment, a computer program, such as the STB computer program 474, is embedded within the STB memory device 472.

In an illustrative embodiment, the client-facing tier 402 includes a client-facing tier (CFT) switch 430 that manages communication between the client-facing tier 402 and the access network 466 and between the client-facing tier 402 and the private network 410. As illustrated, the CFT switch 430 is coupled to one or more data servers, such as D-servers 432, that store, format, encode, replicate, or otherwise manipulate or prepare video content for communication from the client-facing tier 402 to the set-top box devices 416, 424. The CFT switch 430 can also be coupled to a terminal server 434 that provides terminal devices with a point of connection to the IPTV system 400 via the client-facing tier 402. In a particular embodiment, the CFT switch 430 is coupled to a video-on-demand (VOD) server 436 that stores or provides VOD content imported by the IPTV system 400. Further, the CFT switch 430 is coupled to one or more video servers 480 that receive video content and transmit the content to the set-top boxes 416, 424 via the access network 466. Additionally, the client-facing tier 402 can include a ticker/scroller content analysis engine 476 and an alert generator 478 to identify visual ticker content and to generate an alert related to the identified visual ticker content. The client-facing tier 402 may also include alert data 482 and descriptor content 484, which may be accessed by the ticker/scroller content analysis engine 478 to determine an alert format. The ticker/scroller content analysis engine 478 may be coupled to the D-servers 432 and to the CFT switch 430 via the alert generator 478. In a particular example, the ticker/scroller content analysis engine 476 and the alert generator 478 are software modules that are executed by the D-Servers 432. The alert generator 478 may generate an audio alert, a data message, an alarm, a control signal, or any combination thereof, which may be transmitted to the set-top box devices 416, 424. Alternatively, the alert may be sent to another device, such as a personal computer 468 or a wireless communication device 469 via a public network 412 or another network.

In an illustrative embodiment, the client-facing tier 402 can communicate with a large number of set-top boxes, such as the representative set-top boxes 416, 424, over a wide geographic area, such as a metropolitan area, a viewing area, a statewide area, a regional area, a nationwide area or any other suitable geographic area, market area, or subscriber or customer group that can be supported by networking the client-facing tier 402 to numerous set-top box devices. In a particular embodiment, the CFT switch 430, or any portion thereof, can include a multicast router or switch that communicates with multiple set-top box devices via a multicast-enabled network.

As illustrated in FIG. 4, the application tier 404 can communicate with both the private network 410 and the public network 412. The application tier 404 can include a first application tier (APP) switch 438 and a second APP switch 440. In a particular embodiment, the first APP switch 438 can be coupled to the second APP switch 440. The first APP switch 438 can be coupled to an application server 442 and to an Operations Systems and Support/Billing Systems and Support (OSS/BSS) gateway 444. In a particular embodiment, the application server 442 can provide applications to the set-top box devices 416, 424 via the access network 466, which enable the set-top box devices 416, 424 to provide functions, such as interactive program guides, video gaming, display, messaging, processing of video-on-demand (VOD) material and other Internet Protocol Television (IPTV) content, etc. In an illustrative embodiment, the application server 442 can provide location information to the set-top box devices 416, 424. In a particular embodiment, the OSS/BSS gateway 444 includes OSS data, as well as BSS data. In one embodiment, the OSS/BSS gateway 444 can provide or restrict access to an OSS/BSS server 464 that stores operations and billing systems data.

The second APP switch 440 can be coupled to a domain controller 446 that provides Internet access, for example, to users at their computers 468 via the public network 412. For example, the domain controller 446 can provide remote Internet access to IPTV account information, e-mail, personalized Internet services, or other online services via the public network 412. In addition, the second APP switch 440 can be coupled to a subscriber and system store 448 that includes account information, such as account information that is associated with users who access the IPTV system 400 via the private network 410 or the public network 412. In an illustrative embodiment, the subscriber and system store 448 stores subscriber or customer data and creates subscriber or customer profiles that are associated with IP addresses, stock-keeping unit (SKU) numbers, other identifiers, or any combination thereof, of corresponding set-top box devices 416, 424. In another illustrative embodiment, the subscriber and system store stores data associated with capabilities of set-top box devices associated with particular customers.

In a particular embodiment, the application tier 404 can include a client gateway 450 to communicate data directly to the client-facing tier 402. In this embodiment, the client gateway 450 can be coupled directly to the CFT switch 430. The client gateway 450 can provide user access to the private network 410 and the tiers coupled thereto. In an illustrative embodiment, the set-top box devices 416, 424 can access the IPTV system 400 via the access network 466, using information received from the client gateway 450. User devices can access the client gateway 450 via the access network 466, and the client gateway 450 can allow such devices to access the private network 410 once the devices are authenticated or verified. Similarly, the client gateway 450 can prevent unauthorized devices, such as hacker computers or stolen set-top box devices from accessing the private network 410, by denying access to these devices beyond the access network 466.

For example, when the first representative set-top box device 416 accesses the client-facing tier 402 via the access network 466, the client gateway 450 can verify subscriber information by communicating with the subscriber and system store 448 via the private network 410. Further, the client gateway 450 can verify billing information and status by communicating with the OSS/BSS gateway 444 via the private network 410. In one embodiment, the OSS/BSS gateway 444 can transmit a query via the public network 412 to the OSS/BSS server 464. After the client gateway 450 confirms subscriber and/or billing information, the client gateway 450 can allow the set-top box device 416 to access IPTV content and VOD content at the client-facing tier 402. If the client gateway 450 cannot verify subscriber information for the set-top box device 416, e.g., because it is connected to an unauthorized twisted pair, the client gateway 450 can block transmissions to and from the set-top box device 416 beyond the access network 466.

As indicated in FIG. 4, the acquisition tier 406 includes an acquisition tier (AQT) switch 452 that communicates with the private network 410. The AQT switch 452 can also communicate with the operations and management tier 408 via the public network 412. In a particular embodiment, the AQT switch 452 can be coupled to a live acquisition server 454 that receives or acquires television content, movie content, advertisement content, other video content, or any combination thereof, from a broadcast service 456, such as a satellite acquisition system or satellite head-end office. In a particular embodiment, the live acquisition server 454 can transmit content to the AQT switch 452, and the AQT switch 452 can transmit the content to the CFT switch 430 via the private network 410.

In an illustrative embodiment, content can be transmitted to the D-servers 432, where it can be encoded, formatted, stored, replicated, or otherwise manipulated and prepared for communication from the video server(s) 480 to the set-top box devices 416, 424. The CFT switch 430 can receive content from the video server(s) 480 and communicate the content to the CPE 414, 422 via the access network 466. The set-top box devices 416, 424 can receive the content via the CPE 414, 422, and can transmit the content to the television monitors 418, 426. In an illustrative embodiment, video or audio portions of the content can be streamed to the set-top box devices 416, 424.

Further, the AQT switch 452 can be coupled to a video-on-demand (VOD) importer server 458 that receives and stores television or movie content received at the acquisition tier 406 and communicates the stored content to the VOD server 436 at the client-facing tier 402 via the private network 410. Additionally, at the acquisition tier 406, the video-on-demand (VOD) importer server 458 can receive content from one or more VOD sources outside the IPTV system 400, such as movie studios and programmers of non-live content. The VOD importer server 458 can transmit the VOD content to the AQT switch 452, and the AQT switch 452, in turn, can communicate the material to the CFT switch 430 via the private network 410. The VOD content can be stored at one or more servers, such as the VOD server 436.

When users issue requests for VOD content via the set-top box devices 416, 424, the requests can be transmitted over the access network 466 to the VOD server 436, via the CFT switch 430. Upon receiving such requests, the VOD server 436 can retrieve the requested VOD content and transmit the content to the set-top box devices 416, 424 across the access network 466, via the CFT switch 430. The set-top box devices 416, 424 can transmit the VOD content to the television monitors 418, 426. In an illustrative embodiment, video or audio portions of VOD content can be streamed to the set-top box devices 416, 424.

FIG. 4 further illustrates that the operations and management tier 408 can include an operations and management tier (OMT) switch 460 that conducts communication between the operations and management tier 408 and the public network 412. In the embodiment illustrated by FIG. 4, the OMT switch 460 is coupled to a TV2 server 462. Additionally, the OMT switch 460 can be coupled to an OSS/BSS server 464 and to a simple network management protocol (SNMP) monitor server 486 that monitors network devices within or coupled to the IPTV system 400. In a particular embodiment, the OMT switch 460 can communicate with the AQT switch 452 via the public network 412.

In an illustrative embodiment, the live acquisition server 454 can transmit content to the AQT switch 452, and the AQT switch 452, in turn, can transmit the content to the OMT switch 460 via the public network 412. In this embodiment, the OMT switch 460 can transmit the content to the TV2 server 462 for display to users accessing the user interface at the TV2 server 462. For example, a user can access the TV2 server 462 using a personal computer 468 coupled to the public network 412.

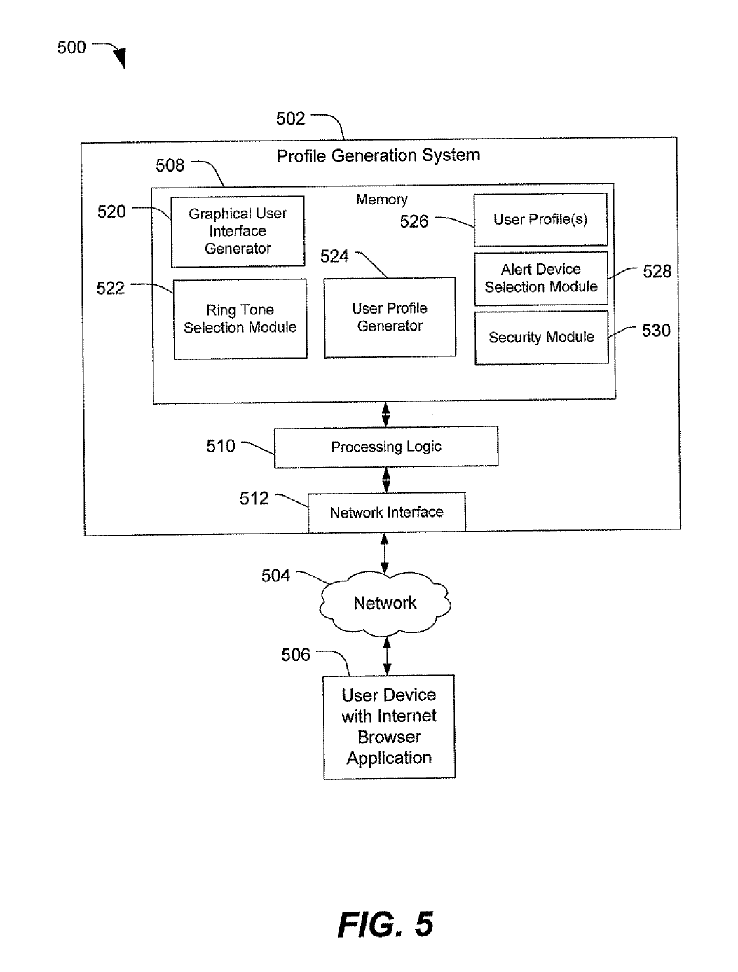

FIG. 5 is a block diagram of a particular illustrative embodiment of a system 500 to provide a graphical user interface to configure an alert. The system 500 includes a profile generation system 502 that communicates with a user device having an Internet browser application 506 via a network 504. The profile generation system 502 includes a network interface 512 that communicates with the network 504, and includes processing logic 510 coupled to the network interface 512 and a memory 508 that is accessible to the processing logic 510. The memory 508 is adapted to store a plurality of modules that are executable by the processing logic 510 to provide an interface that can be accessed by a user to configure settings related to the generation of an alert.

The memory 508 includes a graphical user interface generator 520 that is executable by the processing logic 510 to produce a user interface that may be accessed to configure alert settings. The memory 508 also includes a ring tone selection module 522 that may be executed by the processing logic 510 and accessed by a user to select a particular ring tone setting that can be associated with an alert. The memory 508 also includes a user profile generator 524 that may be executed by the processing logic 510 to generate a user profile based on user account history data, user demographic information, and other data. The user profile may be stored at a user profile(s) storage area 526. The memory 508 also includes an alert device selection module 528 that is executable by the processing logic 510 to provide a user configurable interface for adding and configuring alert devices. The memory 508 also includes a security module 530 that is executable by the processing logic to control access to the profile generation system 502.

In a particular embodiment, a user may utilize the user device with an Internet browser application 506 to communicate with the profile generation system 502 via the network 504. The profile generation system 502 may utilize the security module 530 to authenticate the user and to authorize access to a user profile. The profile generation system 502 uses the graphical user interface (GUI) generator 520 to generate a graphical user interface including profile information and user selectable elements, such as buttons, pull-down menus, check boxes, links, and other elements to allow a user to configure alert settings. The GUI generator 520 may provide a ring tone selection feature using the ring tone selection module 522 to allow a user to configure a ring tone alert setting. For example, the user may assign a particular ring tone as a first alert for information (such as a team's fight song) related to the user's favorite college football team and a second alert (such as an audio version of text data derived from visual ticker information) for stock quote prices related to stocks owned by the user. In a particular embodiment, the user may also register devices using the alert device selection module 528 via the graphical user interface.

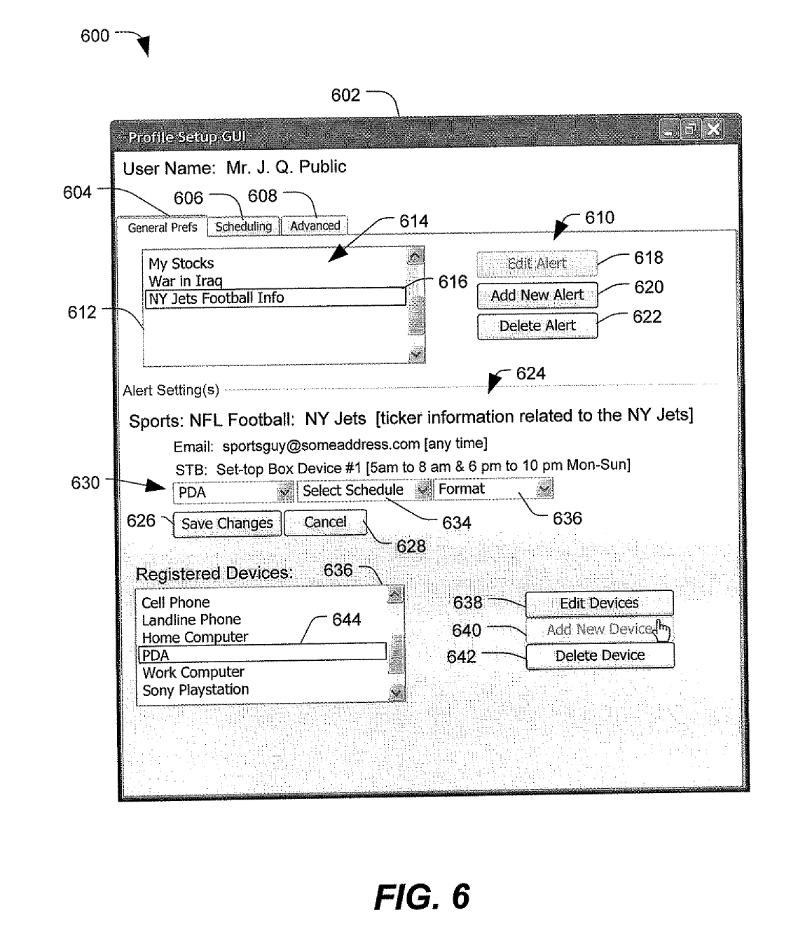

FIG. 6 is a diagram of a particular illustrative embodiment of a graphical user interface (GUI) 600 to configure alerts. The GUI 600 includes a window 602 that has a plurality of user selectable tabs 604, 606, and 608 and a tab pane 610. The plurality of user selectable tabs 604, 606, and 608 include a “General Preferences” tab 604, a “Scheduling” tab 606, and an “Advanced” tab 608. The “General Preferences” tab 604 includes a text box 612 including a list 614 of the user's current types of alert settings. The “NY Jets Football Info” item 616 is selected. The tab pane 610 also includes an “Edit Alert” button 618, an “Add New Alert” button 620, and a “Delete Alert” button 622. In this example, the “Edit Alert” button 618 is selected.

The tab pane 610 also includes a listing of alert settings associated with the selected “NY Jets Football Info” item 616. In this example, the alert settings include previously configured email address and set-top box settings and an editable setting, including a device pull-down item 630, a schedule pull-down item 634, and a format pull-down item 636, which may be accessible to a user via an Internet browser application to configure the alert settings. The tab pane 610 also includes a save button 626 and a cancel button 628 to save or cancel the changes. Additionally, the tab pane 610 includes a list of registered devices 636 and user selectable buttons including an “Edit Devices” button 638, an “Add New Device” button 640, and a “Delete Device” button 642. In this example, a PDA device item 644 is selected and the “Add New Device” button 640 is selected, allowing a user to configure alert settings associated with the selected “NY Jets Football Info” alert 616 to provide the alert to the PDA device (or another device), based on selections made using the pull-down menu items 630, 634, and 636.

In a particular illustrative embodiment, a user may select “PDA” at the device pull-down item 630. The user may also select a particular schedule using the schedule pull-down item 634. Various schedules may be set-up and configured via the “Scheduling” tab 606. In a particular example, a user may configure a business schedule to reflect his/her work schedule. In another particular example, a user may configure an evening schedule, a weekend schedule, a vacation schedule, other schedules, or any combination thereof. The “Select Schedule” pull-down item 634 may reflect the schedule names assigned by a user via the “Scheduling” tab 606. The format pull-down item 636 may be accessed by a user to configure a desired alert format, such as a ring-tone alert, a text message alert, an email message alert, another alert, or any combination thereof. The particular alert options may be limited based on the functionality of the selected device. For example, a mobile phone may have different selectable options from a home control system or a gaming system.

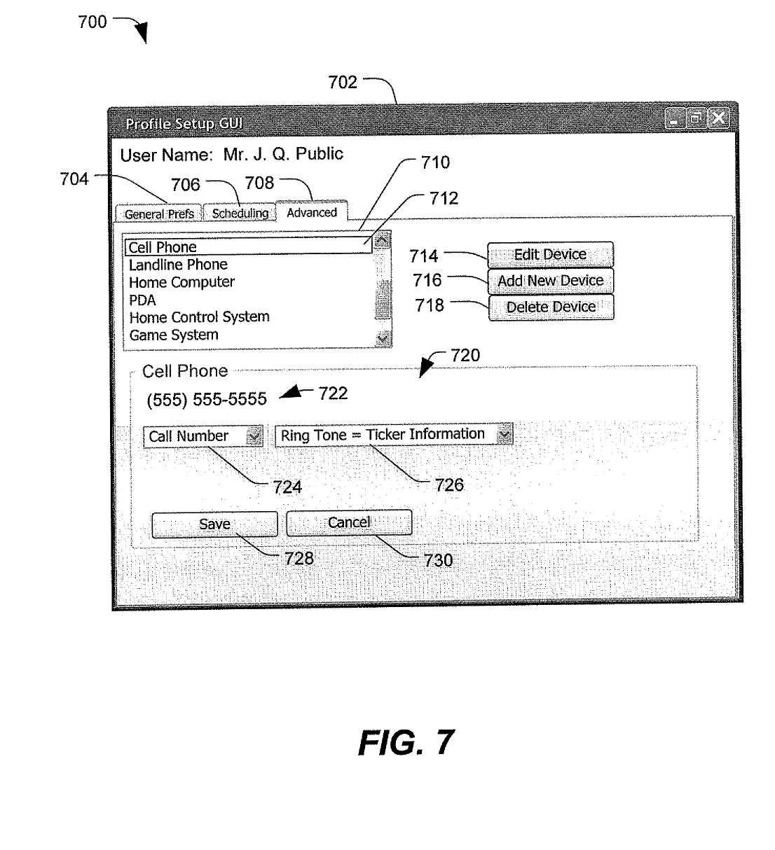

FIG. 7 is a diagram of a second particular illustrative embodiment of a graphical user interface (GUI) 700 to configure alerts. The GUI 700 includes a window 702 having multiple selectable tabs including a “General Preferences” tab 704, a “Scheduling” tab 706, and an “Advanced” tab 708, which is currently selected. In this example, the “Advanced” tab 708 provides a list of user devices 710, including a “Cell Phone,” a “Landline Phone,” a “Home Computer,” a “PDA” (personal digital assistant), a “Home Control System,” and a “Game System.” The “Cell Phone” item 712 is selected. The “Advanced” tab 708 also includes an “Edit Device” button 714, an “Add New Device” button 716, and a “Delete Device” button 718. In this instance, the “Edit Device” button 714 has been selected. The “Cell Phone” settings associated with the selected “Cell Phone” item 712 are displayed, including a cell phone number 722, a selectable pull-down menu 724 to configure the system to send a call alert to the cell phone number 722, and a selectable pull-down menu 726 to specify a format of the alert (e.g., a text message, a special ring tone, a ring tone that includes the visual ticker information, another alert, or any combination thereof). The window 702 also includes a “Save” button 728 and a “Cancel” button 730 to save or cancel any changes.

In a particular illustrative embodiment, the GUI 700 allows a user to register devices and to configure device settings. In this example, the user can access the GUI 700 using an Internet browser application, for example, to register telephones, email accounts, instant message accounts, other devices, or any combination thereof.

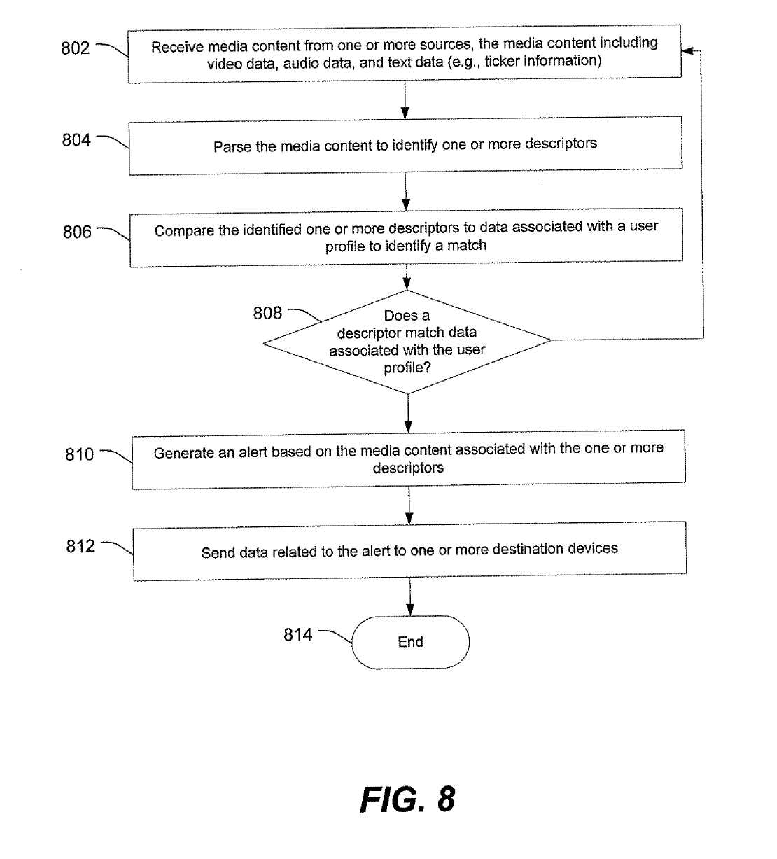

FIG. 8 is a flow diagram of a particular illustrative embodiment of a method of providing an alert. At 802, media content is received from one or more sources. The media content includes video data, audio data, and text data, such as visual ticker information. In a particular embodiment, the media content is received from a content source, such as from a cable television system, a satellite broadcast system, an Internet Protocol Television system, or any combination thereof. Advancing to 804, the media content is parsed to identify one or more descriptors. In a particular embodiment, the one or more descriptors may include text data, embedded triggers, content information, or any combination thereof. In a particular example, the one or more descriptors may include text information derived from visual ticker data included in the media content. The visual ticker data may be a news scroller, a popup, a banner, or other text data within the media content.

Continuing to 806, the identified one or more descriptors are compared to data associated with a user profile to identify a match. In a particular example, content of interest to a particular user may be identified, such as information related to the user's favorite college football team. Advancing to 808, if the descriptor does not match data associated with the user profile, the method returns to 802 and media content is received from one or more sources. Returning to 808, if the descriptor does match data associated with the user profile, the method proceeds to 810, and an alert is generated based on the media content associated with the one or more descriptors. Advancing to 812, data related to the alert is sent to one or more destination devices. In a particular embodiment, the data may include the alert. In another particular embodiment, the data may be a control signal or an alert generation signal that may be received by a selected device and interpreted by the selected device to induce a visual alert, an audio alert, or an environmental alert. For example, the data may include a control signal to cause a home control system to flicker lights proximate to the display device to attract the viewer's attention. The method terminates at 814.

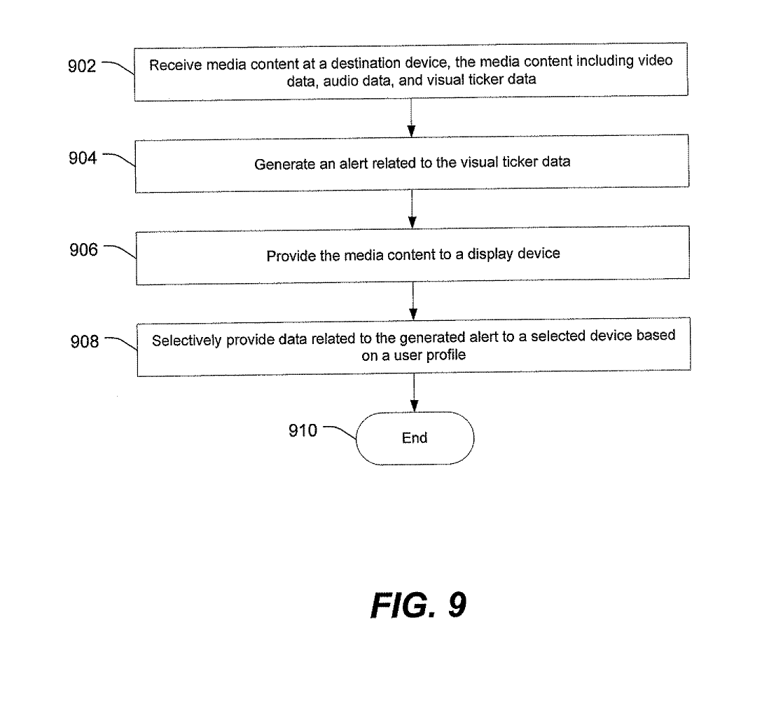

FIG. 9 is a flow diagram of a second particular illustrative embodiment of a method of providing an alert. At 902, media content is received at a destination device, where the media content includes video and audio data and includes visual ticker data. In a particular embodiment, the destination device is a set-top box device.

Continuing to 904, an alert is generated that is related to the visual ticker data. In a particular example, generating the alert includes performing a text-to-speech conversion on text content associated with the visual ticker data to produce an audio version of the visual ticker data. A telephone call can be initiated to a mobile device using the audio version of the visual ticker data as a ring tone for playback at the mobile device. Moving to 906, the media content is provided to a display device. Advancing to 908, the data that is related to the visual ticker data is selectively provided to a selected device based on a user profile. In a particular embodiment, the selected device is a display device including an audio output capability. In another particular embodiment, the selected device includes a wireless telephone, a game system, a portable computer, a personal digital assistant, an audio device, or any combination thereof. In a particular example, selectively providing data related to the alert includes sending a lighting control signal to temporarily alter lighting proximate to the destination device. The method terminates at 910.

In a particular example, the data that is related to the generated alert is selectively provided by determining a selected device based on the text content associated with the visual ticker data, selecting a device based on the text content and based on a user preference, and sending the alert to the selected device. In a particular embodiment, the visual ticker data includes news content, advertising content, sports content, weather information, other data, or any combination thereof. In another particular embodiment, the data related to the alert includes a visual adjustment, an audio adjustment, or any combination thereof, where the visual adjustment and the audio adjustment represent a variation from visual data and audio data associated with the media content. For example, the audio adjustment may temporarily alter a tonal quality associated with audio data of the media content.

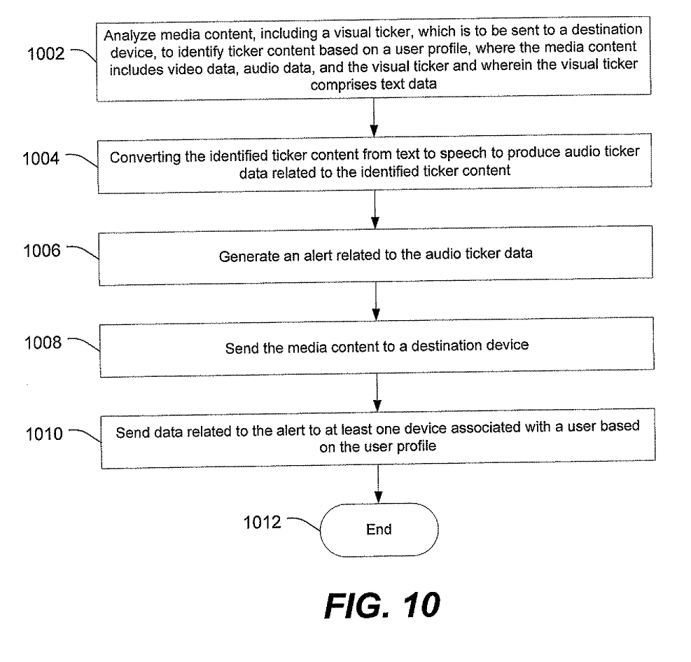

FIG. 10 is a flow diagram of a third particular illustrative embodiment of a method of providing an alert. At 1002, media content including a visual ticker to be sent to a destination device is analyzed to identify ticker content of interest to a user based on a user profile. The media content includes video data, audio data, and the visual ticker, where the visual ticker includes text data. Advancing to 1004, the identified ticker content is converted from text to speech to produce audio ticker data related to the identified ticker content. In a particular embodiment, the conversion of the ticker content is performed using a text-to-speech converter, such as a software module that is executable by a processor or by processing logic. Continuing to 1006, an alert is generated that is related to the audio ticker data. Moving to 1008, the media content is sent to a destination device. Proceeding to 1010, data related to the alert is sent to at least one device associated with the user based on the user profile. In a particular embodiment, the at least one device may be the destination device. For example, the media content and the alert may be sent to a set-top box device that is coupled to a television for reproduction of the media content and the alert. In another particular example, the alert is a ring tone that is sent to a mobile telephone. In another particular example, the alert is a control signal to flash lights proximate to the destination device. In another particular example, the alert can be a control signal to alter an audio parameter, a visual parameter, or any combination thereof at the destination device. In yet another example, the alert can be a low frequency signal that causes a buzzing sound or that draws the attention of the viewer. The method terminates at 1012.

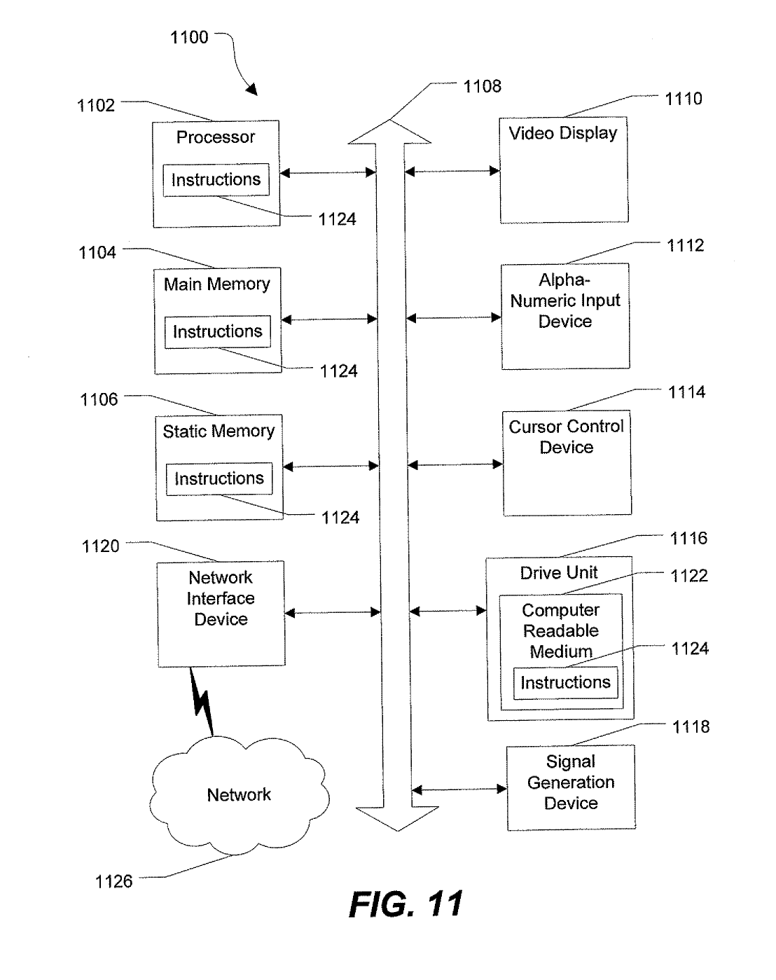

Referring to FIG. 11, an illustrative embodiment of a general computer system is shown and is designated 1100. The computer system 1100 can include a set of instructions that can be executed to cause the computer system 1100 to perform any one or more of the methods or computer based functions disclosed herein. The computer system 1100 may operate as a standalone device or may be connected, e.g., using a network, to other computer systems or peripheral devices. In a particular example, the computer system 1100 represents the content source 102, the residential gateway device 106, the set-top box device 108, the computer 118, the alarm system 112, the phone 116, or other devices 120 illustrated in FIG. 1. Additionally, the computer system 1100 may represent the media content receiver 208 illustrated in FIG. 2 and the set-top box device 304 illustrated in FIG. 3, for example. Further, the computer system 1100 may represent the profile generation system 502 and the user device with the Internet browser application 506 illustrated in FIG. 5.

In a networked deployment, the computer system may operate in the capacity of a server or as a client user computer in a server-client user network environment, or as a peer computer system in a peer-to-peer (or distributed) network environment. The computer system 1100 can also be implemented as or incorporated into various devices, such as a personal computer (PC), a tablet PC, a set-top box (STB), a personal digital assistant (PDA), a mobile device, a palmtop computer, a laptop computer, a desktop computer, a communications device, a wireless telephone, a land-line telephone, a control system, a camera, a scanner, a facsimile machine, a printer, a pager, a personal trusted device, a web appliance, a network router, switch or bridge, or any other machine capable of executing a set of instructions (sequential or otherwise) that specify actions to be taken by that machine. In a particular embodiment, the computer system 1100 can be implemented using electronic devices that provide voice, video or data communication. Further, while a single computer system 1100 is illustrated, the term “system” shall also be taken to include any collection of systems or sub-systems that individually or jointly execute a set, or multiple sets, of instructions to perform one or more computer functions.

As illustrated in FIG. 11, the computer system 1100 may include a processor 1102, e.g., a central processing unit (CPU), a graphics processing unit (GPU), or both. Moreover, the computer system 1100 can include a main memory 1104 and a static memory 1106, that can communicate with each other via a bus 1108. As shown, the computer system 1100 may further include a video display unit 1110, such as a liquid crystal display (LCD), an organic light emitting diode (OLED), a flat panel display, a solid state display, or a cathode ray tube (CRT). Additionally, the computer system 1100 may include an input device 1112, such as a keyboard, and a cursor control device 1114, such as a mouse. The computer system 1100 can also include a disk drive unit 1116, a signal generation device 1118, such as a speaker or remote control, and a network interface device 1120.

In a particular embodiment, as depicted in FIG. 11, the disk drive unit 1116 may include a computer-readable medium 1122 in which one or more sets of instructions 1124, e.g. software, can be embedded. Further, the instructions 1124 may embody one or more of the methods or logic as described herein. In a particular embodiment, the instructions 1124 may reside completely, or at least partially, within the main memory 1104, the static memory 1106, and/or within the processor 1102 during execution by the computer system 1100. The main memory 1104 and the processor 1102 also may include computer-readable media.

In an alternative embodiment, dedicated hardware implementations, such as application specific integrated circuits, programmable logic arrays and other hardware devices, can be constructed to implement one or more of the methods described herein. Applications that may include the apparatus and systems of various embodiments can broadly include a variety of electronic and computer systems. One or more embodiments described herein may implement functions using two or more specific interconnected hardware modules or devices with related control and data signals that can be communicated between and through the modules, or as portions of an application-specific integrated circuit. Accordingly, the present system encompasses software, firmware, and hardware implementations.

In accordance with various embodiments of the present disclosure, the methods described herein may be implemented by software programs executable by a computer system. Further, in an exemplary, non-limited embodiment, implementations can include distributed processing, component/object distributed processing, and parallel processing. Alternatively, virtual computer system processing can be constructed to implement one or more of the methods or functionality as described herein.

The present disclosure contemplates a computer-readable medium that includes instructions 1124 or receives and executes instructions 1124 responsive to a propagated signal, so that a device connected to a network 1126 can communicate voice, video or data over the network 1126. Further, the instructions 1124 may be transmitted or received over the network 1126 via the network interface device 1120.

While the computer-readable medium is shown to be a single medium, the term “computer-readable medium” includes a single medium or multiple media, such as a centralized or distributed database, and/or associated caches and servers that store one or more sets of instructions. The term “computer-readable medium” shall also include any medium that is capable of storing, encoding or carrying a set of instructions for execution by a processor or that cause a computer system to perform any one or more of the methods or operations disclosed herein.

In a particular non-limiting, exemplary embodiment, the computer-readable medium can include a solid-state memory such as a memory card or other package that houses one or more non-volatile read-only memories. Further, the computer-readable medium can be a random access memory or other volatile re-writable memory. Additionally, the computer-readable medium can include a magneto-optical or optical medium, such as a disk or tapes or other storage device to capture carrier wave signals such as a signal communicated over a transmission medium. A digital file attachment to an e-mail or other self-contained information archive or set of archives may be considered a distribution medium that is equivalent to a tangible storage medium. Accordingly, the disclosure is considered to include any one or more of a computer-readable medium or a distribution medium and other equivalents and successor media, in which data or instructions may be stored.

Although the present specification describes components and functions that may be implemented in particular embodiments with reference to particular standards and protocols, the disclosed embodiments are not limited to such standards and protocols. For example, standards for Internet and other packet switched network transmission (e.g., TCP/IP, UDP/IP, HTML, HTTP) represent examples of the state of the art. Such standards are periodically superseded by faster or more efficient equivalents having essentially the same functions. Accordingly, replacement standards and protocols having the same or similar functions as those disclosed herein are considered equivalents thereof.

The illustrations of the embodiments described herein are intended to provide a general understanding of the structure of the various embodiments. The illustrations are not intended to serve as a complete description of all of the elements and features of apparatus and systems that utilize the structures or methods described herein. Many other embodiments may be apparent to those of skill in the art upon reviewing the disclosure. Other embodiments may be utilized and derived from the disclosure, such that structural and logical substitutions and changes may be made without departing from the scope of the disclosure. Additionally, the illustrations are merely representational and may not be drawn to scale. Certain proportions within the illustrations may be exaggerated, while other proportions may be reduced. Accordingly, the disclosure and the figures are to be regarded as illustrative rather than restrictive.

One or more embodiments of the disclosure may be referred to herein, individually and/or collectively, by the term “invention” merely for convenience and without intending to voluntarily limit the scope of this application to any particular invention or inventive concept. Moreover, although specific embodiments have been illustrated and described herein, it should be appreciated that any subsequent arrangement designed to achieve the same or similar purpose may be substituted for the specific embodiments shown. This disclosure is intended to cover any and all subsequent adaptations or variations of various embodiments. Combinations of the above embodiments, and other embodiments not specifically described herein, will be apparent to those of skill in the art upon reviewing the description.

The Abstract of the Disclosure is provided to comply with 37 C.F.R. §1.72(b) and is submitted with the understanding that it will not be used to interpret or limit the scope or meaning of the claims. In addition, in the foregoing Detailed Description, various features may be grouped together or described in a single embodiment for the purpose of streamlining the disclosure. This disclosure is not to be interpreted as reflecting an intention that the claimed embodiments require more features than are expressly recited in each claim. Rather, as the following claims reflect, inventive subject matter may be directed to less than all of the features of any of the disclosed embodiments. Thus, the following claims are incorporated into the Detailed Description, with each claim standing on its own as defining separately claimed subject matter.

The above-disclosed subject matter is to be considered illustrative, and not restrictive, and the appended claims are intended to cover all such modifications, enhancements, and other embodiments, which fall within the true spirit and scope of the present invention. Thus, to the maximum extent allowed by law, the scope of the present invention is to be determined by the broadest permissible interpretation of the following claims and their equivalents, and shall not be restricted or limited by the foregoing detailed description.

What is claimed is:

1. A method of providing an alert related to visual ticker information for display at a display device, the method comprising:
receiving media content at a destination device, the media content including video data, audio data and visual ticker data;
generating an alert related to the visual ticker data;
providing the media content to a display device; and
selectively providing data related to the alert to a selected device based on a user preference.

2. The method of claim 1, wherein the destination device comprises a set-top box device, and wherein the selected device comprises a display device including an audio output capability.

3. The method of claim 1, wherein the selected device comprises at least one of a wireless telephone, a game system, a portable computer, a personal digital assistant, and an audio device.

4. The method of claim 1, wherein selectively providing data related to the alert comprises sending a lighting control signal to temporarily alter lighting proximate to the destination device.

5. The method of claim 1, wherein generating the alert comprises performing a text-to-speech conversion on text content associated with the visual ticker data to produce an audio version of the visual ticker data.

6. The method of claim 5, further comprising initiating a call to a mobile device using the audio version of the visual ticker data as a ring tone for playback at the mobile device.

7. The method of claim 5, wherein selectively providing the data related to the alert comprises:
determining a selected device based on the text content associated with the visual ticker data;
selecting a device based on the text content and based on a user preference; and
sending the data related to the alert to the selected device.

8. The method of claim 1, wherein the visual ticker data comprises news content, sports content, advertising content, weather information, or any combination thereof.

9. The method of claim 1, wherein the data related to the alert comprises a visual adjustment, an audio adjustment, or any combination thereof, wherein the visual adjustment and the audio adjustment represent a variation from data associated with the media content.

10. A method of providing an alert to a user device, the method comprising:
analyzing media content including a visual ticker to be sent to a destination device, the media content including video data, audio data, and the visual ticker, wherein the visual ticker comprises text data;
sending the media content to the destination device; and
sending an alert related to the visual ticker to at least one device associated with a user of the destination device based on the user profile.

11. The method of claim 10, wherein the at least one device comprises the destination device.

12. The method of claim 10, further comprising:
converting the text data of the visual ticker to converted audio data using a text-to-speech converter; and
generating the alert using the converted audio data.

13. The method of claim 12, wherein the alert comprises a ring tone, and wherein the at least one device comprises a mobile telephone.

14. The method of claim 10, wherein the alert comprises a control signal to flash lights proximate to the destination device.

15. The method of claim 10, wherein the alert comprises a control signal to alter an audio parameter, a visual parameter, or any combination thereof at the destination device.

16. The method of claim 10, wherein the alert comprises a low frequency signal.

17. An alert generation system comprising:
a content analysis engine adapted to receive media content including audio data, video data, and text data, the content analysis engine to identify selected content from the media content based on a user profile;
a text-to-speech converter adapted to convert text data associated with the selected content into converted audio data;
an alert generator adapted to generate an alert based on the converted audio data; and
an alert interface adapted to selectively transmit data related to the generated alert to one or more destination devices according to the user profile.

18. The system of claim 18, wherein the one or more destination devices include a wireless telephone.

19. The system of claim 18, wherein the alert comprises a ring tone that includes the audio data.

20. The system of claim 17, wherein the alert interface is adapted to identify a destination device from a list of destination devices associated with a user based on the user profile and to transmit the data related to the generated alert to the identified destination device.

21. The system of claim 17, wherein the text data is from a visual ticker associated with the media content.

22. The system of claim 17, wherein the alert interface is adapted to communicate data related to the generated alert to a first destination device via a first communication protocol and to a second destination device via a second communication protocol.

23. The system of claim 17, wherein the alert interface is adapted to communication data related to the generated alert to a first destination device via a first communication network and to a second destination device via a second communication network.

24. The system of claim 17, further comprising an interface to a media content network.

25. The system of claim 17, further comprising an interface to a content server adapted to provide media content.
